(19) United States
(12) Patent Application Publication
(10) Pub. No.: US 2024/0158300 A1
(43) Pub. Date: May 16, 2024

(54) RAPID CONDITIONING IN CARBONATED PRECAST CONCRETE PRODUCTION

(71) Applicant: Carbicrete Inc., Montreal (CA)

(72) Inventors: Hucheng QI, London (CA); Mehrdad MAHOUTIAN, Montréal (CA); Han LI, Montreal (CA); Sanoop KUMAR, Laval (CA)

(21) Appl. No.: 18/389,425

(22) Filed: Nov. 14, 2023

Related U.S. Application Data
(60) Provisional application No. 63/383,514, filed on Nov. 14, 2022.

(51) Int. Cl. C04B 28/08; C04B 40/00; C04B 40/02

(52) U.S. Cl. CPC C04B 28/082; C04B 40/006; C04B 40/0231; C04B 2111/1037

(57) ABSTRACT

A method of manufacturing a concrete product, includes: mixing a composition including a binder, water, and an aggregate to produce a concrete mixture, a major portion of a weight of the aggregate attributed to particles sized to pass through sieve openings of about 2.36 mm; imparting a form to the concrete mixture to provide a formed intermediate; conditioning the formed intermediate to obtain a conditioned intermediate; and curing the conditioned intermediate with a gas containing carbon dioxide to obtain the concrete product.

### TECHNICAL FIELD

This disclosure relates generally to concrete products and, more particularly, to systems and methods used for manufacturing such concrete products.

### BACKGROUND

In manufacturing traditional concrete products, a dry mixture, which may include a cement and aggregate, is mixed with water. The resultant intermediate typically undergoes a conditioning step, in which some of the water it contains is evaporated. The conditioned intermediate product subsequently undergoes a separate curing step, in order to obtain the final concrete product. The conditioning step is however time-consuming and may be quite sensitive. Poor performance and/or quality of the finished product can result if this conditioning step is not executed properly. Hence, improvements are sought.

### SUMMARY

There is provided a method of manufacturing a concrete product, comprising: mixing a composition including a binder, water, and an aggregate to produce a concrete mixture, a major portion of a weight of the aggregate attributed to particles sized to pass through sieve openings of about 2.36 mm; imparting a form to the concrete mixture to provide a formed intermediate; conditioning the formed intermediate to obtain a conditioned intermediate; and curing the conditioned intermediate with a gas containing carbon dioxide to obtain the concrete product.

The method may also include any one or more of the following features, in whole or in part, and in any combination.

In some embodiments, the conditioning of the formed intermediate includes conditioning the formed intermediate for about 50% less time than if the composition of the formed intermediate were made with a reference aggregate, a major portion of a weight of the reference aggregate attributed to particles sized to be retained by the sieve openings of about 2.36 mm.

In some embodiments, at least 90% of the weight of the aggregate is attributed to the particles sized to pass through the sieve openings of about 2.36 mm.

In some embodiments, 100% of the weight of the aggregate is attributed to the particles sized to pass through the sieve openings of about 2.36 mm.

In some embodiments, the major portion of the weight of the aggregate is attributed to particles sized to pass through sieve openings of about 1.18 mm.

In some embodiments, the major portion of the weight of the aggregate is attributed to particles sized to pass through sieve openings of about 0.3 mm.

In some embodiments, the major portion of the weight of the aggregate is attributed to particles sized to pass through sieve openings of about 0.15 mm.

In some embodiments, the major portion of the weight of the aggregate is attributed to particles sized to pass through sieve openings of about 0.075 mm.

In some embodiments, the sieve openings have an area of about 5.57 mm2.

In some embodiments, the sieve openings are square.

In some embodiments, the method includes mixing the binder, the water, and the aggregate with the particles including one or more of sand, crushed stone, expanded perlite, expanded shale, crushed glass, crushed air-cooled granulated blast furnace slag, recycled concrete, recycled brick, stone rubble.

In some embodiments, the binder includes steel slag.

In some embodiments, the binder is devoid of cement.

In some embodiments, a binder content of the binder ranges from 8% to 50% by weight of the concrete mixture.

In some embodiments, a water-to-binder ratio ranges from 0.15 to 0.5.

In some embodiments, the mixing of the composition includes mixing a chemical admixture with the binder, the aggregate, and the water to produce the composition.

In some embodiments, the method includes conditioning the formed intermediate at a temperature ranging from 15° C. to 28° C. and with a relative humidity ranging from 20% to 60%.

In some embodiments, the conditioning of the formed intermediate includes conditioning the formed intermediate until from 20% to 80% by weight of the water is evaporated.

In some embodiments, the curing of the conditioned intermediate includes exposing the formed intermediate to the gas containing carbon dioxide at a pressure ranging from 0 psi to 120 psi.

In some embodiments, the method includes curing the conditioned intermediate for from 5 minutes to 72 hours at a temperature ranging from 20° C. to 80° C. and at a relative humidity ranging from 20% to 90%.

In some embodiments, the method includes mixing the binder, the water, and the aggregate having a dry rodded density of from 1100 kg/m3 to 1850 kg/m3.

### BRIEF DESCRIPTION OF THE DRAWINGS

Reference is now made to the accompanying figures in which:

FIG. 1 is a schematic view of a system used for curing and conditioning a concrete product;

FIG. 2A is a flowchart illustrating steps of a method of manufacturing a concrete product in accordance with one embodiment;

FIG. 2B is a flowchart illustrating sub-steps of the method of FIG. 2A;

FIG. 3 is a top view illustrating a sieve in accordance with one embodiment;

FIG. 4 is a graph illustrating size distribution of particles of a coarse aggregate and of aggregate A used in some of the examples;

FIG. 5 is a graph illustrating size distribution of particles of aggregate B used in some of the examples;

FIG. 6 is a graph illustrating size distribution of particles of aggregates C and D used in some of the examples;

FIG. 7 is a graph illustrating mass loss in the freeze and thaw testing of carbonated precast concrete, in accordance with an exemplary embodiment; and

FIG. 8 is a schematic representation of a controller in accordance with one embodiment.

### DETAILED DESCRIPTION

### Introduction

There remains growing interest worldwide to reduce the environmental footprint of precast concrete. Carbonation curing technology is among the most promising solutions. During carbonation curing, precast concrete hardens mainly through the so-called carbonation reaction which happens between carbon dioxide and the oxides, and/or hydroxide of calcium and/or magnesium, with the existence of water. Under appropriate raw material selection, mix design and process control, carbonated precast concrete may be as strong and durable as traditional precast concrete, and suitable for a variety of applications.

Manufacturing precast concrete with carbonation curing technology may address concerns over climate change. Under appropriate processing condition, freshly cast concrete products may achieve rapid hardening when being exposed in CO₂-rich environment. Depending on its composition, one tonne of precast concrete has the potential of permanently fixing up to 200 kg CO₂ in less than 24 hours of early-age carbonation. This may help to mitigate the CO₂ emissions associated with the construction industry. Other advantages of carbonated precast concrete may include the improvement of productivity through rapid hardening, the reduction of production cost through the replacement of ordinary Portland cement with environmental-friendly and less expensive binders such as steel slag, and so on.

A long and often energy-consuming conditioning process may be required in the manufacture of carbonated precast concrete. Carbonation curing is normally conducted after concrete products have been cast to monolithic blocks or slabs with varying shape and dimensions. Precast concrete in this consolidated condition may not be favored for direct carbonation curing due to its limited pore space. Furthermore, both the excessive water required by a good workability and the low porosity required by strength and other quality specifications may pose a challenge for CO₂ gas to penetrate to the core of the consolidated precast concrete. Put differently, there is a compromise to be made in a quantity of water added to the composition to ensure good workability while obtaining a porosity adequate for penetration of CO₂. Therefore, the consolidated precast concrete is often required to go through a conditioning process prior to carbonation curing, in order to achieve rapid CO₂ uptake and strength gain. This conditioning process has other terms such as preconditioning, or precuring or pre-drying process. It may last for 1 hour or longer with the help of a fan in some embodiments. In some cases, its purpose is to drive 25-70% of initial mixing water out of the consolidated precast concrete. The actual extent of the required moisture loss depends on the dimensions of the consolidated precast concrete, the pressure of CO₂ gas, and other factors. During the subsequent carbonation curing process, the pores generated by the evaporated water may facilitate the penetration of CO₂ gas into the core of consolidated precast concrete; and the precipitation of formed calcium carbonation, leading to satisfactory CO₂ uptake and early strength for carbonated precast concrete. If the conditioning process is not long enough, low CO₂ uptake, poor strength, and poor CO₂ penetration may be encountered in carbonated precast concrete.

There are some shortcomings associated with applying a conditioning process in carbonated precast concrete production. The use of fan drying (e.g., air blower) consumes energy thus increasing the impact of carbonated precast concrete production to the environment. The whole process may increase capital and operation costs in carbonated precast concrete production, due to the purchase of drying equipment, the requirement for drying space, the consumption of energy, the reduction in productivity, and the required moisture-monitoring activities in process control. Additionally, the process may impair the surface quality of carbonated precast concrete as a result of excessively removing the moisture in the outer surfaces of consolidated precast concrete in an effort to achieve a desired moisture loss deep in its core.

The current disclosure is based on an unexpected finding when the impact of aggregate's particle size on the production and performance of carbonated precast concrete is investigated. The inventors of the present disclosure discovered that the conditioning time may be significantly reduced while CO₂ uptake, strength and durability of carbonated precast concrete may be improved, if the maximum size of aggregate is reduced to a certain level. More detail about the size of the particle of the aggregate are presented below.

### Curing System

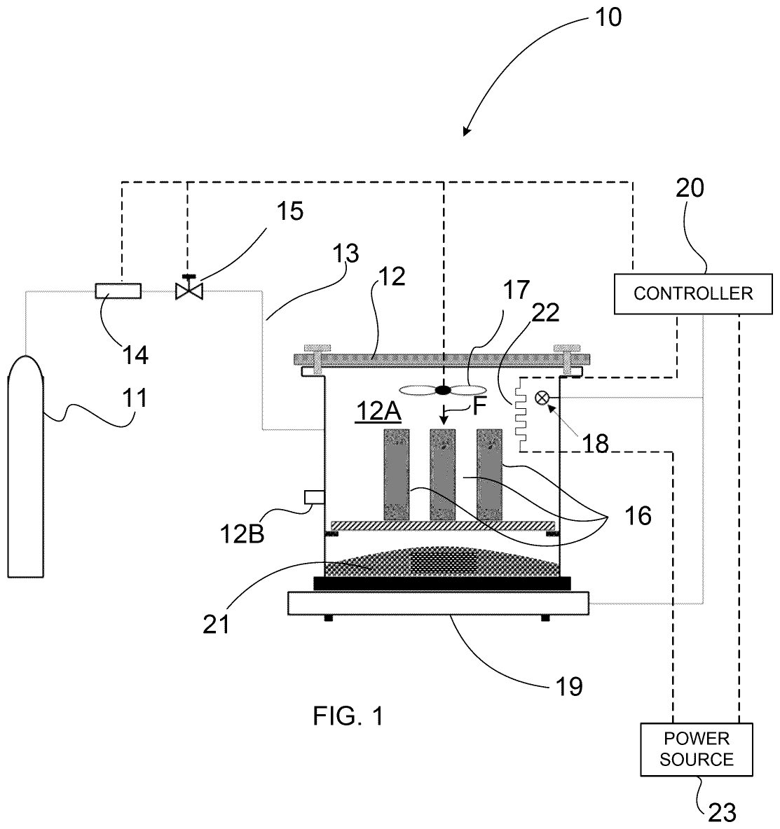

Referring now to FIG. 1, an exemplary system for conditioning and curing a concrete product is shown at 10. The system 10 includes a source of carbon dioxide 11, which may be a reservoir or tank, pneumatically connected to an enclosure 12 via a line 13. In the embodiment shown, the system 10 includes a heater 14 for heating the carbon dioxide as it flows from the source of carbon dioxide 11 to the enclosure 12. In the present configuration, the system 10 includes a valve 15 that may be selectively open or closed to allow or restrict the flow of carbon dioxide toward the enclosure 12.

The enclosure 12 defines an inner space or chamber 12A, also referred to as a curing chamber, that is sized to accept the plurality of concrete products 16 to be cured. In the embodiment shown, the enclosure 12 includes top bottom and side walls interconnected to one another in an airtight manner. In the context of the present disclosure, “airtight” implies that there is little to no leakage of gas through the enclosure 12 at a pressure differential the enclosure 12 is subjected to. The pressure differential corresponds to a difference between the pressure inside the enclosure 12 and an ambient pressure outside the enclosure 12. The enclosure 12 may be structurally designed to withstand a pressure differential created by a greater pressure of the carbon dioxide inside the enclosure 12 than an atmospheric pressure outside the enclosure 12. A blower 17 may be located in the chamber 12A of the enclosure 12 and is operable to generate an airflow F that may accelerate the conditioning and/or curing process.

In some embodiments, the enclosure 12 may be used to cure the concrete products 16 using a low-pressure curing. In the context of the present disclosure, the expression “low-pressure” implies pressures that exceed the ambient pressure by at most 10% of the ambient pressure. More detail about low-pressure curing are presented in U.S. patent application Ser. No. 17/581,320 filed Jan. 21, 2022, the entire content of which is incorporated herein by reference. The enclosure 12 may be a deployable structure (e.g. bag).

The system 10 may further include one or more sensors 18, which may include one or more of a temperature sensor and a humidity sensor. The temperature sensor and humidity sensor 18 are operatively connected to the chamber 12A and are operable generate one or more signals indicative of a temperature and a humidity level inside the enclosure 12. A scale or balance 19 may support the enclosure 12 and is used to measure a weight variation of the concrete products 16 during the conditioning and curing phase. The balance 19 may send a signal indicative of a weight of the enclosure 12 containing the concrete products 16. More specifically, water content of the concrete products 16 is expected to partially evaporate during the conditioning and curing phase. The balance 19 may measure this weight variation and may be used to determine whether the conditioning and curing process is completed.

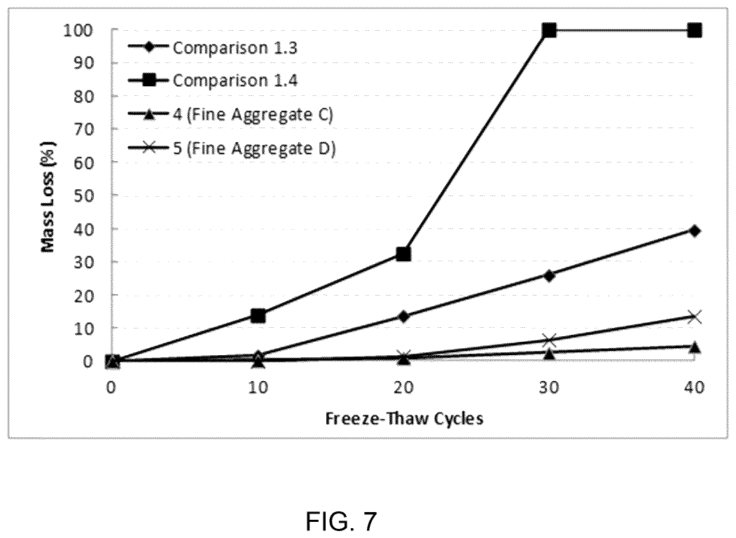

In the embodiment shown, the system 10 includes a controller 20 that may be operatively connected to the temperature and humidity sensor 18, to the balance 19, to the heater 14, to the blower 17, and to the valve 15. The controller 20 may therefore independently control the injection of carbon dioxide through the valve 15 and the actuation of the blower 17. In the embodiment shown, the controller 20 includes a computing device 800 such as the one shown and described below with reference to FIG. 7. The controller 20 may act as a data logger to save temperatures, weights, pressures, etc. data points during the conditioning and curing process. The controller 20 is operable to receive data from the temperature and humidity sensor 18 and from the balance 19; and to control operating parameters of the heater 14, the valve 15, and the blower 17. These operating parameters may include, for instance, a temperature of the heater 14 to achieve a desired temperature of the gas injected in the enclosure 12, whether the valve 15 should be opened, closed, or at an intermediate position to control a flow of carbon dioxide through the valve 15, a rotational speed of the blower 17, and so on.

In some embodiments, the conditioning phase occurs while concrete products 16 are located inside the enclosure 12. During the conditioning phase, it is expected that water would be released from the concrete product 16. Since the enclosure 12 is closed to an environment outside the enclosure 12, it may be desirable to absorb the extracted humidity from the concrete product. In the present case, a desiccant material 21 is located inside the enclosure 12 and is used to absorb excess humidity. A desiccant material may be a hygroscopic material that is used to induce or sustain a state of dryness in its vicinity. These desiccant materials may absorb water. The desiccant material may, in one particular example, include silica gel. Desiccant materials may be in forms other than solid, and may work through other principles, such as chemical bonding of water molecules. Desiccant materials may include, in any combinations, activated charcoal, calcium sulfate, calcium chloride, zeolites, and so on. The desiccants materials may be adsorbent materials as opposed to absorbent material. An absorbent material would contain the water by allowing the water to penetrate through it. An absorbent material may be porous and the water may be absorbed by penetrating porosities of the absorbent material. An adsorbent material will stick to water molecules. In other words, the water will be detained by the adsorbent material by being adhered to a surface of the adsorbent material. The adsorbent material may attract moistures and hold it like a magnet on its surface. It will be understood that any means able to extract humidity from the enclosure 12 during the simultaneous curing and conditioning may be used. For instance, a de-humidifier, an air conditioning, and any other suitable means may be used.

In the embodiment shown, the system 10 may include a heating element 22 located within the chamber 12A for increasing a temperature inside the chamber 12A to perform a post-hardening process, which will be described further below. The heating element 22 may be operatively connected to a power source 23 and to the controller 20, which may control operation of the heating element 22. It will be appreciated that any suitable means used for increasing a temperature within the chamber 12A are contemplated. For instance, chemical components generating an exothermic reaction when mixed may be disposed inside the chamber 12A. The chamber 12A may be heated by heating walls of the enclosure 12. This may be done with gas, electricity, induction, hot water, and so on.

### Method

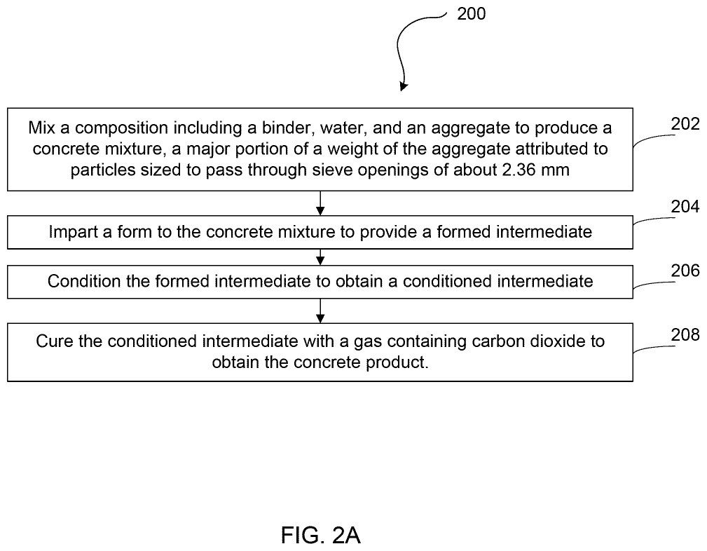

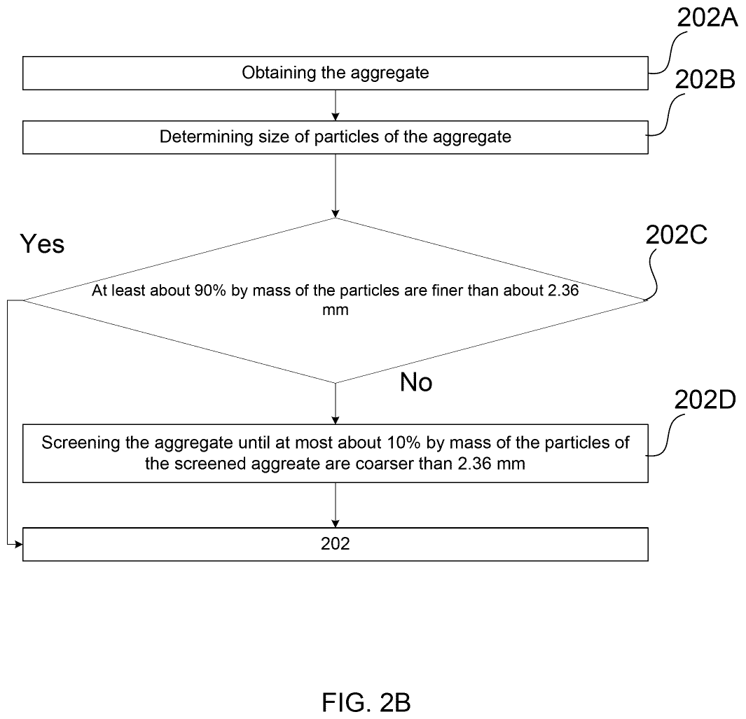

Referring now to FIG. 2A, a method of manufacturing a concrete product is shown at 200. The method 200 includes mixing a composition including a binder, water, and an aggregate to produce a concrete mixture, a major portion of a weight of the aggregate attributed to particles sized to pass through sieve openings of about 2.36 mm at 202; imparting a form to the concrete mixture to provide a formed intermediate at 204; conditioning the formed intermediate to obtain a conditioned intermediate at 206; and curing the conditioned intermediate with a gas containing carbon dioxide to obtain the concrete product at 208.

In the context of the present disclosure, the expression “major portion of a weight” implies at least 50% of the weight. In some embodiments, the expression “major portion” implies at least 60%, preferably at least 70%, preferably at least 80%, and preferably at least 90%. In the embodiment shown, at least 90% of the weight of the aggregate is attributed to the particles sized to pass through the sieve openings of about 2.36 mm. In some embodiments, 100% of the weight of the aggregate is attributed to the particles sized to pass through the sieve openings of about 2.36 mm. The major portion of the weight of the aggregate may be attributed to particles sized to pass through sieve openings of about 1.18 mm. The major portion of the weight of the aggregate may be attributed to particles sized to pass through sieve openings of about 0.3 mm. The major portion of the weight of the aggregate may be attributed to particles sized to pass through sieve openings of about 0.15 mm. The major portion of the weight of the aggregate may be attributed to particles sized to pass through sieve openings of about 0.075 mm. The particles are coarser than 0 mm or 0.01 mm.

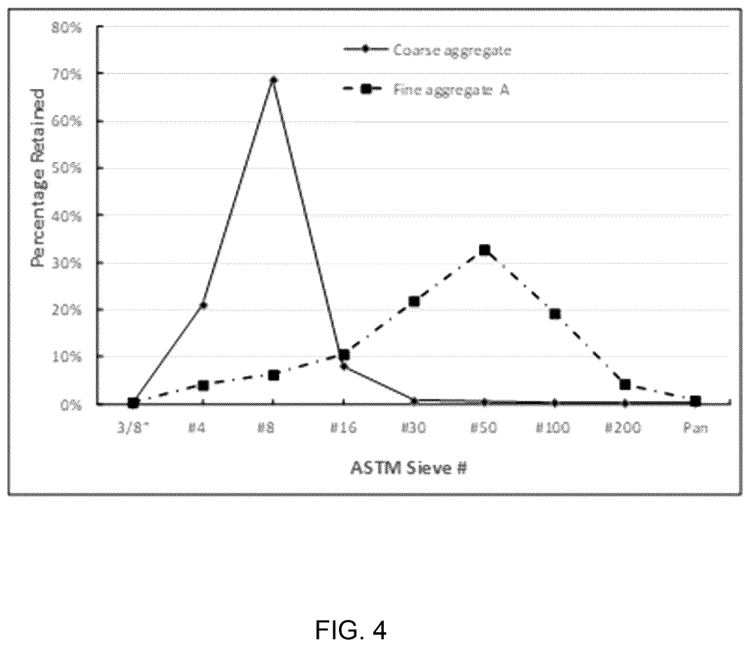

Because of the finer particles of aggregates, the conditioning time may be substantially reduced. For instance, in some embodiments, the conditioning of the formed intermediate may include conditioning the formed intermediate for about 50% less time than if the formed intermediate were made with a reference aggregate. A major portion of a weight of the reference aggregate is attributed to particles sized to be retained by the sieve openings of about 2.36 mm. The reference aggregate may correspond to the coarse aggregate whose composition is illustrated in FIG. 4. In this coarse aggregate about 70% of its mass are retained by the No. 8 sieve.

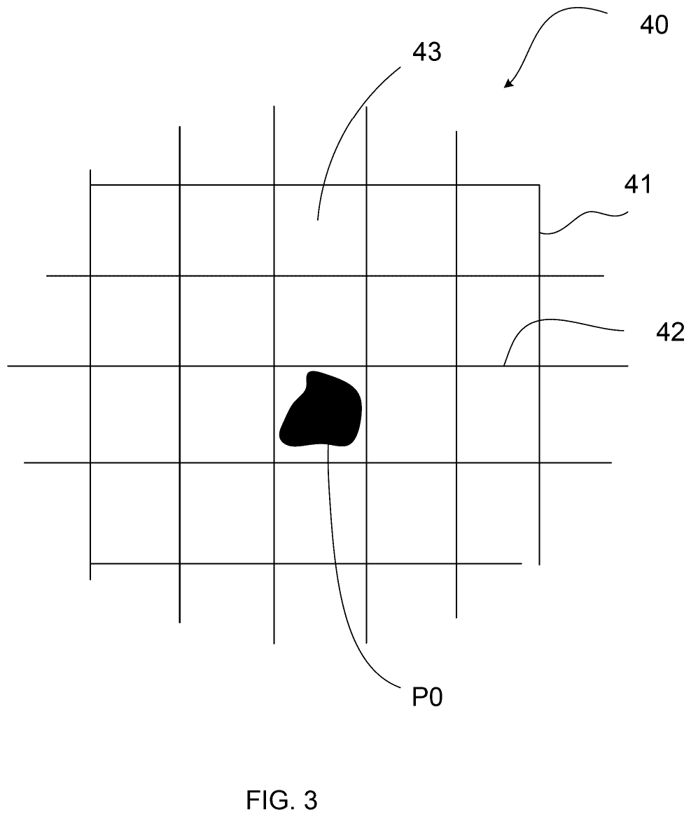

Referring to FIG. 3, an exemplary sieve is shown at 40. In the embodiment shown, the sieve 40 includes longitudinal wires 41 and transversal wires 42 intersecting one another at substantially 90 degree angles. Sieve openings 43 are defined between the longitudinal wires 41 and the transversal wires 42. In the embodiment shown, the sieve openings 43 are square, but other shapes (e.g., round) may be used in some embodiments. An area of the sieve openings 43 may be about 5.57 mm² for a sieve opening of 2.36 mm (2.36×2.36). Therefore, the expression “sieve opening” denotes a dimension of the opening between two points connected via a line intersecting a center of the sieve opening. For instance, for square sieve openings as shown in FIG. 3, the sieve opening corresponds to a shortest distance between two adjacent longitudinal wires 41 (or two adjacent transversal wires 42). For circular openings, the sieve opening corresponds to a diameter of the opening.

The sieve openings refer to openings of sieves as defined by sieving standards such as ASTM Ell, ISO 565, or ISO 3310-1. For instance, the sieve openings of 2.36 mm are for a No. 8 sieve. The number of a sieve (e.g., No. 8) refers to a number of openings by linear inch. In the case of a No. 8 sieve, 8 sieve openings are defined by linear inch. The sieve openings are smaller than an eighth of an inch since a diameter of wires composing the sieve decrease the space available for the sieve openings.

Aggregate sizes or ranges thereof which are provided herein without a lower limit, such as “the aggregate being composed of particles that are finer than about 2.36 mm” for example, are understood to mean that the aggregate particles are finer than 2.36 mm and are necessarily coarser than 0 or as closed to 0 as is practically possible (for example 0.01 mm). Stated differently, an aggregate size provided herein as being less than a value X mm is understood to mean that the aggregate particle sizes may be between 0.01 mm and X mm.

### Aggregate

Carbonated precast concrete is a composite material that is essentially composed of a binding medium within which are embedded fragments of aggregate. This composite material is hardened in an enriched CO₂ environment normally at its early age. Examples of carbonated precast concrete products include concrete pipes, traffic barriers, walls including retaining walls, boxes including modular boxes, culverts, tiles, pavers, foundations, slabs including hollow-core slabs, patio slabs, steps, curbs, concrete masonry units, beams, floors, columns, manholes, sewage pipes, railroad ties, and other precast concrete products.

The aggregate used in carbonated precast concrete production is typically a binary blend of coarse aggregate and fine aggregate. Coarse aggregate generally refers to aggregate with particle size larger than 4.75 mm (No. 4 sieve). Fine aggregate refers to aggregate with particle size smaller than 4.75 mm. ASTM C33 specifies the quality requirements for coarse aggregate and fine aggregate. Similar specifications are also given by local government or regulatory authority, e.g., OPSS 1002, AASHTO M6 and AASHTO M80. The decision in selecting the right type and blend of aggregate is often influenced by the experience gained in manufacturing and evaluating conventional precast concrete, and also limited by supplying availability.

Among the required quality of aggregate, the maximum size and the grading of the particles are two important parameters. It is believed to affect the material cost, workability, surface quality and void content of precast concrete. Determined by the product type, application and minimum thickness (or depth) of precast concrete, the minimum clear spacing between reinforcing bars (if applicable), and the supplying availability, the maximum allowable size of coarse aggregate is often 37.5 mm (1½″). The most frequently used maximum size of coarse aggregate is 19 mm (¾″) or 9.5 mm (⅜″). For fine aggregate, it is allowed to contain a maximum of 5% (mass) particles coarser than 4.75 mm (No. 4 sieve) by ASTM C33. About the grading of aggregate, well-graded coarse or fine aggregate is generally preferred for precast concrete production, i.e., the aggregate is preferred to have relatively consistent or fair representation from every size of particle within the specified sieve sizes. For fine aggregate, an empirical factor called fineness modulus is also chosen to represent the weighted average size and distribution of the aggregate. It is obtained by summing the accumulated percentages retained on the sieves of the standard series: Nos. 4, 8, 16, 30, 50, and 100 (with openings 4.75, 2.36, 1.18, 0.6, 0.3 and 0.15 mm), and then dividing the sum by 100. The higher the fineness modulus, the coarser is the aggregate. According to the specification of ASTM C33, the fineness modulus of fine aggregate should be 2.3-3.1.

Although generally accounting for 50-75% of the volume in carbonated precast concrete, aggregate is often considered as an inert filler. The possible impact of aggregate on the manufacture and performance of carbonated precast concrete has been long overlooked.

In one embodiment of the current disclosure, the disclosed carbonated precast concrete is made of aggregate with no more than 10% accumulated mass retained on No. 8 sieve (2.36 mm opening) and larger-size sieves. In another embodiment of current disclosure, the disclosed carbonated precast concrete is made of aggregate with 100% passing No. 8 sieve (2.36 mm opening). In another embodiment of current disclosure, the disclosed carbonated precast concrete is made of aggregate with 100% passing No. 16 sieve (1.18 mm opening). In another embodiment of current disclosure, the disclosed carbonated precast concrete is made of aggregate with 100% passing No. 30 sieve (0.6 mm opening). In another embodiment of current disclosure, the disclosed carbonated precast concrete is made of aggregate with 100% passing No. 50 sieve (0.3 mm opening). In another embodiment of current disclosure, the disclosed carbonated precast concrete is made of aggregate with 100% passing No. 100 sieve (0.15 mm opening). In another embodiment of current disclosure, the disclosed carbonated precast concrete is made of aggregate with 100% passing No. 200 sieve (0.075 mm opening). In a further embodiment of the present disclosure, the disclosed carbonated precast concrete is made of sieved fine aggregate with 100% passing No. 8 (2.36 mm) and removed with particle 100% passing No. 100 sieve (0.15 mm opening).

In the context of the present disclosure, the expression “no more than Y % accumulated mass retained on No. X sieve” implies that, for a given mass of aggregate (e.g., 1 kg) no more than Y % of that mass will be retained on the No. X sieve. For instance, saying “no more than 10% accumulated mass retained on No. 8 sieve (2.36 mm opening)” means that for one kilogram of aggregate, no more than 100 grams of that aggregate will be retained on the No. 8 sieve; the remaining 900 grams of the aggregate will pass through openings of the No. 8 sieve.

Additionally, the disclosed carbonated precast concrete is made of fine aggregate with varying density. In one embodiment, the disclosed carbonated precast concrete is made of normal-weight aggregate, with dry rodded density in the range of 1100-1850 kg/m3. In another embodiment, the disclosed carbonated precast concrete is made of lightweight aggregate, with dry rodded density less than about 1100 kg/m3. In a further embodiment, the disclosed carbonated precast concrete is made of heavyweight aggregate, with dry rodded density greater than 2100 kg/m3, respectively.

The “dry rodded density” used herein refers to a mass per unit volume of dry aggregate, which includes the volume of the particles and the voids between the particles, compacted by rodding. Rodding compaction is a process by which a compaction force is applied to the aggregate to increase particle to particle contact and decrease the volume of the voids between those particles.

In addition, the disclosed carbonated precast concrete is made of fine aggregate from different sources. In one embodiment, the disclosed carbonated precast is made of natural origin, such as sand. In another embodiment, the disclosed carbonated precast is made of manufactured aggregate from natural origin, such as crushed stone fine, expanded perlite, expanded shale, and so on. In a further embodiment, the disclosed carbonated precast is made of manufactured aggregate from recycled sources, such as crushed glass, crushed air-cooled granulated blast furnace slag, crushed construction and demolition waste (recycled concrete, brick, and stone rubble), and so on. Furthermore, in one embodiment, the disclosed carbonated precast concrete is made of a combination of the above-mentioned aggregates in terms of their particle size, and/or source, and/or density. In some embodiments, some slag may be used as a binder whereas some other slag may be used as an aggregate. A difference between slag as a binder and slag as an aggregate pertains mainly the particle size; slag as aggregate is usually much coarser than the slag as binder. In some cases, slag as a binder may differ from slag as an aggregate by their chemical compositions and reactivity to carbon dioxide or water; to make a slag as a binder, it has to be ground sufficiently fine and it has to have the compounds to react with carbon dioxide or water to harden. In one embodiment, particles of slag as used as a binder are finer than 0.8 mm whereas particles of slag as used as an aggregate have a fineness of greater than 0.8 mm (i.e. they are coarser than 0.8 mm). Therefore, if the aggregate includes particles of slag, these particles of slag are coarser than 0.8 mm.

The step 202 of mixing the composition may include mixing the composition with the aggregate having the characteristics described below. The percentage values below refer to mass percentages. In one embodiment, the disclosed carbonated precast concrete is made of aggregate with 10% or less accumulated mass retained on No. 8 and larger-size sieves, i.e., 90% or more of aggregate is finer than 2.36 mm. In another embodiment, the disclosed carbonated precast concrete is made of aggregate with 0% retained on No. 8 and larger-size sieves, i.e., 100% of aggregate is finer than 2.36 mm. In another embodiment, the disclosed carbonated precast concrete is made of aggregate with 0% retained on No. 16 and larger-size sieves, i.e., 100% of aggregate is finer than 1.18 mm. In another embodiment, the disclosed carbonated precast concrete is made of aggregate with 0% retained on No. 30 and larger-size sieves, i.e., 100% of aggregate is finer than 0.6 mm. In another embodiment, the disclosed carbonated precast concrete is made of aggregate with 0% retained on No. 50 and larger-size sieves, i.e., 100% of aggregate is finer than 0.3 mm. In another embodiment, the disclosed carbonated precast concrete is made of aggregate with 0% retained on No. 100 and larger-size sieves, i.e., 100% of aggregate is finer than 0.15 mm. In another embodiment, the disclosed carbonated precast concrete is made of aggregate with 0% retained on No. 200 and larger-size sieves, i.e., 100% of aggregate is finer than 0.075 mm. In a further embodiment, the disclosed carbonated precast concrete is made of sieved fine aggregate with 100% retained between No. 8 and smaller size sieves up to No. 100 (0.15 mm), i.e., 100% of aggregate is finer than 2.36 mm and larger than 0.15 mm.

Additionally, the disclosed fine aggregate can be of natural, or manufactured, or recycled origin. Furthermore, the described fine aggregate may be normal weight, or lightweight, or heavy weight according to its density. The described fine aggregate can also be a combination of a plurality of the above-mentioned aggregates in terms of their particle size, and/or source, and/or density. Thus, the aggregate may have many portions by mass, each of these portions may include particles having a respective density, fineness, and origin. The disclosed carbonated precast concrete may have the advantage of requiring at least 50% less conditioning time than regular carbonated precast concrete. In addition, the disclosed carbonated precast concrete may have greater CO₂ uptake, strength, and durability than regular carbonated precast concrete.

Herein, the expression “finer than X mm”, where “X” is a numerical value, means that a particle of the aggregate has passed or is capable of passing through a sieve with a nominal aperture size of “X” mm, by following the sieve analysis method instructed by ASTM C136 (Standard Test Method for Sieve Analysis of Fine and Coarse Aggregates). For instance, if a particle of the aggregate is finer than about 2.36 mm, it implies that this particle has passed (or is capable of passing) though a sieve with a nominal aperture size of 2.36 mm by following the ASTM C136 method. Similarly, the expression “coarser than Y mm”, where “Y” is a numerical value, means that a particle of the aggregate has retained on sieve with nominal aperture size larger than and equal to “Y” mm by following the ASTM C136 method.

The step 202 of mixing the composition may include selecting the aggregate. To do so, before the aggregate is used for carbonated precast concrete production, its particle size is examined. If the examined aggregate has >10% accumulated mass retained on No. 8 and larger-size sieves, i.e., if >10% of the examined aggregate is coarser than 2.36 mm, the examined aggregate has to be screened with a sieve having a controlled size of opening, so that the screened aggregate has 0% particles coarser than 2.36 mm. In one embodiment, the screened aggregate is required to pass No. 8 sieve, i.e., 100% of the screened aggregate is smaller than 2.36 mm. In another embodiment, the screened aggregate is required to pass No. 16 sieve, i.e., 100% of the screened aggregate is smaller than 1.18 mm. In another embodiment, the screened aggregate is required to pass No. 30 sieve, i.e., 100% of the screened aggregate is smaller than 0.6 mm. In another embodiment, the screened aggregate is required to pass No. 50 sieve, i.e., 100% of the screened aggregate is smaller than 0.3 mm. In another embodiment, the screened aggregate is required to pass No. 100 sieve, i.e., 100% of the screened aggregate is smaller than 0.15 mm. In a further embodiment, the screened aggregate is required to pass No. 200 sieve, i.e., 100% of the screened aggregate is smaller than 0.075 mm. The screened aggregate can then be accepted for making carbonated precast concrete.

If the examined aggregate has ≤10% accumulated mass retained on No. 8 and larger-size sieves, i.e., if less than or equal to 10% of the examined aggregate is coarser than 2.36 mm, it may be used directly (without screening) for carbonated precast concrete production. The aggregate with controlled particle size and approved for carbonated precast concrete production is preferred to have a fineness modulus of 2.5 or smaller. Additionally, the aggregate approved for carbonated precast concrete production may be of natural, or manufactured, or recycled origin. Furthermore, the aggregate approved for carbonated precast concrete production can be normal weight, or lightweight, or heavy weight according to its density. The aggregate approved for carbonated precast concrete production can also be a combination of the above-mentioned aggregates in terms of their particle size, and/or source, and/or density.

It has been observed that time required for the conditioning step at 206 may be reduced by the size of particles of aggregate. Moreover, the concrete product may have improved carbon dioxide uptake, strength, and durability.

Referring to FIG. 2B, the step 202 of mixing the composition including the binder, the aggregate, and the water may include preliminary steps for providing the aggregate of suitable size. The step 202 of mixing the composition may thus be preceded by a step of obtaining the aggregate at 202A; determining a size of the particles of the aggregate at 202B; determining whether at least about 90% of by mass of the particles are finer than about 2.36 mm at 202C; if at least about 90% of by mass of the particles are finer than about 2.36 mm, then the method goes through the step 202 of the mixing the aggregate, the binder, and the water described with reference to FIG. 2A. Otherwise, if more than about 10% by mass of the particles of the aggregate are coarser than about 2.36 mm, then the method proceeds to screening the aggregate until at most 10% by mass of the particles of the screened aggregate are coarser than 2.36 mm at 202D. Then, the method proceeds to the mixing at 202.

Stated differently, the method 200 may include a step of determining the suitable size for the aggregate. The manufacture of disclosed carbonated precast concrete starts by collecting representative sample from the aggregate intended for concrete production and then analyzing its gradation, which may be done by following the procedures for fine aggregate in ASTM C136. After sieve analysis, the amount of aggregate particles retained in each specific sieve and the resulting fineness modulus are obtained. The mass percentage of particles coarser than sieve No. 8 (2.36 mm opening) is then compared to a predetermined value. If the tested aggregate has less than or equal to 10% accumulated mass retained on No. 8 and larger-size sieves, it may be used directly for carbonated precast concrete production. This accepted aggregate can be sufficiently fine. For example, in some embodiments, 100% of its particles may be sized such that they can pass through a No. 200 sieve (0.075 mm opening). However, if the tested aggregate has more than 10% accumulated mass retained on No. 8 sieves, a screening step has to be preformed to remove some coarse particles from the aggregate such that no more than 10% accumulated mass retention on No. 8 sieves after screening. The screened aggregate may then be used for carbonated precast concrete production. Ideally, the opening size of the screen used in this coarse-particle-removal process should be 2.36 mm or reasonably larger, for a purpose of obtaining a screened aggregate with acceptable particle size by removing minimum amount of coarse particles. Nevertheless, any screen with an opening smaller than 2.36 mm can be used if finer aggregate is desired. For example, the opening of the screen can be 1.18 mm, or 0.6 mm, or 0.3 mm, or 0.15 mm, or 0.075 mm. There are many suitable ways to perform the screening process, for example with a vibratory screening equipment.

The aggregate which has been accepted for carbonated precast concrete production may have a fineness modulus of 2.5 or smaller The fineness modulus may be obtained by summing the accumulated percentages retained on the sieves of the standard series: Nos. 4, 8, 16, 30, 50, and 100 (with openings of respectively 4.75, 2.36, 1.18, 0.6, 0.3 and 0.15 mm), and then dividing the sum by 100. The higher the fineness modulus, the coarser is the aggregate. This accepted aggregate is allowed to have a wide range in its density. It may be a normal-weight aggregate, with dry rodded density in the range of 1100-1850 kg/m³. It may also be a lightweight aggregate, with a dry rodded density less than 1100 kg/m³. It may be a heavyweight aggregate, with a dry rodded density greater than 2100 kg/m³. In addition, this aggregate may be supplied from different sources of origin. It may be natural sand. It may be manufactured aggregate from natural origin, such as crushed stone, expanded perlite, expanded shale, and so on. It may be manufactured aggregate from recycled sources, such as crushed glass, crushed air-cooled granulated blast furnace slag, crushed construction and demolition waste (recycled concrete, brick, and stone rubble), and so on. Furthermore, this aggregate may be any combination of above-mentioned aggregates in terms of their particle size, and/or source, and/or density.

In the method 200, the step 202 mixing the composition may include providing the mixing the binder, the water, and the aggregate in which 100% of the particles of aggregate are finer than 2.36 mm. In some embodiments, it may include mixing the binder, the water, and the aggregate in which the particles of aggregate are finer than 1.18 mm. In some embodiments, it may include mixing the binder, the water, and the aggregate in which the particles of aggregate are finer than 0.3 mm. In some embodiments, it may include mixing the binder, the water, and the aggregate in which the particles of aggregate are finer than 0.15 mm. In some embodiments, it may include mixing the binder, the water, and the aggregate in which the particles of aggregate are finer than 0.075 mm. In some embodiments, it may include mixing the binder, the water, and the aggregate in which 100% of the particles of aggregate are finer than 2.36 mm and removed with 100% of the particles finer than 0.15 mm. In some embodiments, it may include mixing the binder, the water, and the aggregate having a dry rodded density of from 1100 kg/m3 to 1850 kg/m3. In some embodiments, it may include mixing the binder, the water, and the aggregate having a dry rodded density of at most 1100 kg/m3. In some embodiments, it may include mixing the binder, the water, and the aggregate having a dry rodded density of at least 2100 kg/m3. In some embodiments, it may include mixing the binder, the water, and the aggregate including one or more of sand, crushed stone, expanded perlite, expanded shale, crushed glass, crushed air-cooled granulated blast furnace slag, recycled concrete, recycled brick, stone rubble.

In some embodiments, the aggregate is finer than 2.38 mm, preferably finer than 1.18 mm, preferably finer than 0.6 mm, preferably finer than 0.3 mm, preferably finer than 0.15 mm, and more preferably finer than 0.075 mm. The mixture may be free of coarse aggregate. In some embodiments, the mixture may comprise a mix of aggregates being finer than 2.38 mm and coarser than 0.15 mm while being free of coarse aggregate. In some embodiments, the mixture may comprise a mix of aggregates being finer than 2.38 mm and coarser than 0.15 mm while including some coarse aggregates. An aggregate may be considered coarse if it is coarser than about 4.75 mm. The aggregate may have few carbon dioxide reactive chemical phases such as calcium oxide, calcium hydroxide, calcium silicate, dicalcium silicate, tricalcium silicate, magnesium oxide and magnesium hydroxide.

### Binder, Water, and Additives

After the aggregate suitable for manufacturing the disclosed carbonated precast concrete is determined, attention is turned to other raw materials of the mixture. These raw materials include binders, water and additives (e.g., chemical admixtures).

The binder(s) suitable for manufacturing the disclosed carbonated precast concrete should be reactive towards carbon dioxide.

The binder(s) suitable for manufacturing the disclosed carbonated precast concrete may be any or a combination of cementitious and supplementary cementitious binders, which are termed conventional “binders” in this disclosure. The conventional binders are the ones currently accepted for normal (non-carbonated) precast concrete production. These binders may include: ordinary Portland cement (OPC), high alumina cement, white cement, calcium sulfoaluminate cement, magnesium cement, hydrated lime, supplementary cementitious materials including ground granulated blast furnace slag (GGBFS), fly ash, bottom ash, and natural and calcined pozzolanic materials, and OPC blended with limestone or supplementary cementitious materials.

The binder(s) suitable for manufacturing the disclosed carbonated precast concrete may include emerging binders, which have weak or no hydraulic activity and also have not been recognized as supplementary cementitious materials. The main characteristics of the emerging binders are low cost and low carbon footprint, because they are either derived from waste sources or manufactured with less energy consumption and CO₂ emission than conventional cementitious binders. These binders include: belite cement, wollastonite, steel slag, bottom ash from municipal solid waste incineration, and so on.

The binder(s) suitable for manufacturing the disclosed carbonated precast concrete may include any combination of conventional binders and/or emerging binders. Preferably, the binder that is suitable for manufacturing the disclosed carbonated precast concrete contains at least 10% by weight emerging binders. More preferably, the binder that is suitable for manufacturing the disclosed carbonated precast concrete contains at least 25% by weight emerging binders. More preferably, the binder that is suitable for manufacturing the disclosed carbonated precast concrete contains at least 50% by weight emerging binders. More preferably, the binder that is suitable for manufacturing the disclosed carbonated precast concrete contains at least 75% by weight emerging binders. More preferably, the binder that is suitable for manufacturing the disclosed carbonated precast concrete contains 100% by weight emerging binders.

As shown in the examples below, steel slag may be used herein as the sole component of a binder for carbonated precast concrete production. “Steel slag” herein refers to the slag by-product produced from making steel. Steel slag may include slag produced from Basic Oxygen Furnaces (BOF), also known as slag from the Linz-Donawitz (LD) process, or LD slag. Steel slag may also include slag produced from Electric Arc Furnaces (EAF). Steel slag as used herein may further include ladle slag, which is produced as a by-product from a ladle refining operation. Steel slag as used herein may further include stainless steel slag generated from stainless steel production, which is mainly generated from the argon oxygen decarburization (AOD) and/or ladle metallurgy (LM) process. In addition, steel slag can be a combination of above slags. For example, “EBH slag” as used herein refers to EAF-BOF Hybrid, which is a type of steel slag formed of a mixture of EAF and BOF produced slags.

In one embodiment, the steel slag used herein has a cumulative calcium silicate content (ex: CS+C₂S+C₃S phase concentration) of at least about 15% by weight. In one embodiment, the steel slag used herein has a cumulative calcium silicate content (ex: CS+C₂S+C₃S phase concentration) of at least about 20% by weight. In one embodiment, the steel slag used herein has a cumulative calcium silicate content (ex: CS+C₂S+C₃S phase concentration) of at least about 30% by weight. In one embodiment, the steel slag used herein has a cumulative calcium silicate content (ex: CS+C₂S+C₃S phase concentration) of at least about 40% by weight. In one embodiment, the steel slag used herein has a SiO₂ content of at least about 6% or more preferably at least about 15% by weight.

The steel slag may include a mixture of coarse slag pieces and fine slag pieces. Coarse slag pieces may have a Blaine fineness less than about 50 m²/kg and fine slag pieces may have a Blaine fineness greater than about 50 m²/kg. The coarse slag pieces, the fine slag pieces, or both may be land-filled as an outcome from typical steel making process. Received steel slag originating from waste (such as land-fill and/or industrial waste) may optionally be refined. Refining the steel slag may include filtering the received steel slag to separate fine slag pieces from coarse slag pieces. Alternatively, or additionally, refining the received steel slag may also include pulverizing the steel slag to a fine powder. In some exemplary embodiments, the filtered fine pieces are pulverized while coarser pieces are not pulverized. For example, for EAF steel slag, the slag may be pulverized to a Blaine fineness of at least 50 m²/kg, and preferably about 180 m²/kg. For example, for EBH steel slag (mix of EAF and BOF and ladle slag), the slag may be pulverized to a Blaine fineness of at least 100 m²/kg and preferably about 240 m²/kg. In other exemplary embodiments, the steel slag may be pulverized to a finer size. In another example, at least fifty percent of ground slag may be smaller than 100 microns, and at least ten percent of ground slag may be smaller than 50 microns, i.e., D(50)<100 microns, and D(10)<50 microns.

It will be understood that “steel slag” as used herein excludes iron slag and blast furnace slag that are typically generated during iron production and that may be used in making cement, such as pozzolanic slag.

Any potable water is suitable for the production of the disclosed carbonated precast concrete. The addition amount of water should be controlled to the minimum value for a desired workability of concrete mixture, for the considerations of reducing conditioning time and also achieving the desired concrete density with the available manufacturing tools.

Additives that are suitable for manufacturing the disclosed carbonated precast concrete include any or a combination of the following: air entraining admixture, water reducing admixture, water repellent admixture, accelerating admixture, retarding admixture, rheology modifier, efflorescence control admixture, foaming agent, alkali silica reaction inhibitor, shrinkage reducer, corrosion inhibiting admixture, pigment, mineral admixture, reinforcing fiber, polymer, and so on. The dosages of the additives used to manufacture the disclosed carbonated precast concrete follow the general rules which are known for people with ordinary skill in the art.

In some embodiments, the providing of the composition includes providing the composition including one or more chemical admixture and/or one or more mineral. The chemical admixture may include an accelerator, a retarder, a viscosity modifying agent, an air entertainer, a foaming agent, an alkali silica reaction inhibitor, an anti-wash-out, a corrosion inhibitor, a shrinkage reducer, a concrete crack reducer, a plasticizer, a super plasticizer, a sealer, a paint, a coating, a water reducer, a water repellant, an efflorescence controller, a polymer powder, a polymer latex, and a workability retainer. The mixing of the composition at 202 may include mixing the composition with one or more of cellulose fibers, glass fibers, micro synthetic fibers, natural fibers, polypropylene fibers, polyvinyl alcohol fibers, and steel fibers.

In some embodiments, the method 200 includes mixing the water, the aggregate, and the binder including steel slag. In some embodiments, the method 200 includes mixing the water, the aggregate, and the binder having a binder content being from 8% to 50% by weight of the concrete mixture. The binder may be devoid of cement. The binder may consist of steel slag.

In the context of the present disclosure, the expressions “binder” and “cement” have different meaning. A cement, such as Ordinary Portland Cement, is a kind of binder. A cement may be considered a binder, but not all binders are cements.

### Mixture & Forming

In the embodiment shown, the step 202 of the mixing of the binder, the aggregate, and the water to produce the concrete mixture may include producing a wet mixture having a mixture water-to-binder ratio. The mixing of the binder, the aggregate, and the water to produce the concrete mixture at 202 may include producing a dry mixture having a different mixture water-to-binder ratio. Generally, the content binder in the mixture varies from 8% to 50%, in accordance with the binder type and also the application of carbonated precast concrete. The water-to-binder ratio may be about 0.15-0.50. There are many suitable ways to perform the mixing of the concrete mixture, for example with a pan mixer.

Herein, the imparting of the form to the concrete mixture at 204 includes casting the concrete mixture in a mould to provide a moulded intermediate. The method 200 of the present embodiment includes a step of demoulding the moulded intermediate to provide a demolded intermediate. In some embodiments, the carbon curing of the formed intermediate at 208 may include curing the formed intermediate while the formed intermediate is still in the mould. Alternatively, the carbon curing at 208 may include curing the demolded intermediate.

At step 204, the imparting of the form to the concrete mixture may include forming and consolidating the concrete mixture under compaction and vibration to provide the formed intermediate. In some embodiments, the imparting of the form may include transferring the freshly prepared concrete mixture by any appropriate means and casting in a prepared mould. The mould may be made of steel, iron, aluminum, plastic, FRP or another material. The mould may be pre-lubricated prior to casting in order to facilitate the demoulding process. If using a wet mix, it may be consolidated within the mould by internal or external vibrators. In some cases, the consolidation step lasts no more than 120 seconds. Dry cast concrete may be compacted/pressed/pressurized/formed into the mould by compaction and or vibration. The imparting of the form at 204 may include casting the concrete mixture in a shape of a precast, a concrete pipe, a box culvert, a draining product, a paving slab, a floor slab, a traffic barrier, a wall manhole, a retaining wall, a paver, a tile, or a shingle.

In some embodiments, the method 200 may include demoulding the formed intermediate before the carbon curing of step 208. The method may include conditioning the formed intermediate until a water-to-binder ratio, which corresponds to a first water-to-binder ratio after the imparting of the form at 204, reaches a second water-to-binder ratio lower than the first water-to-binder ratio. After the conditioning step at 206, the conditioned intermediate may be demolded to provide a demolded conditioned intermediate. This demolded conditioned intermediate may then go through the carbon curing step at 208.

In some embodiments, the method 200 includes inserting a reinforcing material inside the mould before the casting of the concrete mixture. The inserting of the reinforcing material may include inserting bars made of the reinforcing material, the reinforcing material including one or more of carbon steel, stainless steel, and fiber reinforced polymer.

In some embodiments, the water-to-binder ratio before the conditioning at 206 may be about 0.2 with normal aggregates and from 0.07 to 0.1 with finer aggregates as described herein. The water-to-binder ratio may be about 0.15 before the conditioning at 206. Thus, the finer aggregates may result in having to extract less moisture from the intermediate. This may, in turn, reduce a time of the condition step at 206. Other water-to-binder ratios are contemplated depending of the binders and aggregates being used.

After a homogeneous mixture with a desired workability is obtained following the step 202 of mixing the binder, aggregate, and water, the mixture may be emptied from the mixer and then transported to the molding place. The step 204 of imparting a form to the concrete mixture may require an amount of the mixture to be cast into a mould with pre-set dimensions and shape, followed with being leveled. Consolidation is then conducted to condense precast concrete mixture in the mold to the required thickness or height. Consolidation may be achieved through the known ways, such as any or a combination of vibration, compaction and compression.

After molding is completed, the consolidated precast concrete may be taken out of the mould or demolded immediately if it is rigid enough. Otherwise, the consolidated precast concrete may required to be maintained in the mold for a period generally less than 24 hours. This may be referred to as a pre-curing step. This process may help the consolidated precast concrete to obtain sufficient green strength before being demolded. It happens when a wet concrete mixture is used for precast concrete forming. Pre-curing, if required, may be conducted at room temperature. It can also be accelerated at elevated temperature.

In some embodiments, the mixing of the binder, the aggregate, and the water includes mixing the binder, the aggregate, and the water to obtain a water-to-binder ratio of from 0.15 to 0.5.

### Conditioning

Although the conditioning step at 206 may start when the consolidated precast concrete remains in the mould, it may alternatively occur after the formed intermediate has been demolded. It may be conducted at room conditions with a temperature of 15-28° C. and a relative humidity of 20-60%. In some embodiments, the conditioning at 206 may be assisted with a forced air circulation by the fan 17. Other known ways of reducing the moisture, e.g. heat, can be alternatively used during the conditioning step. Alternatively, no forced air circulation may be used during the conditioning step, if energy saving is preferred and a longer time for conditioning is acceptable. This conditioning step may help to reduce the moisture content of precast concrete through water evaporation. The released moisture leaves numerous pores inside the consolidated precast concrete, which may allow to achieve a desired CO₂ uptake and a uniform carbonation throughout the whole precast concrete product.

The duration of the conditioning step at 206 may be determined by the desired extent of initial water or moisture loss from the consolidated precast concrete, which is affected by the dimension and initial water-to-binder ratio of precast concrete, and other variables. As a general rule of thumb, for a precast concrete with a thickness of 30 mm or greater, an initial water loss of 20-80% (by mass) may be required for the conditioned precast concrete to achieve satisfactory CO₂ uptake and strength as well as 100% CO₂ penetration, if carbonation curing is required to be completed in hours instead of days.

The degree of CO₂ penetration may be visually determined by spraying phenolphthalein indicator onto the whole cross section of carbonated precast concrete after it is broken by strength testing. The percentage of the area without pink color against the whole cross area is estimated as degree of CO₂ penetration. For example, a 100% CO₂ penetration is obtained if no pink color is observed in the tested cross section area, while a 50% CO₂ penetration is obtained if pink color occupies a half of the tested cross section area.

Due to the use of finer aggregate disclosed herein, the conditioning time required for manufacturing the disclosed carbonated precast concrete may be significantly decreased. As shown in the examples described below, carbonated precast concrete made of finer aggregate disclosed herein may need a conditioning time only 0.25 hour, instead of a conditioning time of 1 hour required for precast concrete with regular-size aggregate. For predetermined binder content and water-to-binder ratio, precast concrete with coarser aggregate would have a thicker layer of paste to cover each aggregate particle and also possibly more paste agglomerating among the pores between aggregate particles. By reducing the particle size of fine aggregates, the increased surface area of aggregate particles would need more paste to cover. This may help to reduce the thickness of paste coverage for each aggregate particle, and also reduce the tendency of paste agglomeration in the pores. As a result of this paste thinning effect, CO₂ gas may penetrate to the reaction site more easily, and also the formed calcite may precipitate more easily as well during the carbonation curing process. Therefore, a shorter conditioning time may be possible for manufacturing carbonated precast concrete made of finer aggregates disclosed herein.

In some embodiments, the conditioning of the formed intermediate includes conditioning the formed intermediate at a temperature ranging from 15° C. to 28° C. and with a relative humidity ranging from 30% to 60%. In some embodiments, the conditioning of the formed intermediate includes conditioning the formed intermediate until from 20% to 80% by weight of the water is evaporated. In some embodiments, the conditioning of the formed intermediate includes exposing the formed intermediate to a forced air flow.

The conditioning time is a function of the size or volume of the concrete product. Longer conditioning time is needed for a thicker or larger concrete product. The conditioning time for a determined concrete product may be reduced by at least 50% with the suggested aggregate. Another factor influencing the conditioning time is the velocity of the air flow when forced drying is used, the relative humidity of the environment in which the intermediate is being conditioned, the temperature of this environment, and the microstructures (capillaries and pores) of the intermediate.

### Carbonation Curing

After the conditioning step at 206, the conditioned precast concrete goes through the carbon curing step at 208. Carbon dioxide gas, which may have a purity ranging from 5% to 99.9% may be used for carbonated precast concrete production. The pressure of carbon dioxide gas may be adjusted to from 0 MPa to 0.827 MPa (0-120 psi) during the carbonation curing process which may last from 5 minutes up to 72 hours at around 20-80° C. temperature and 20-90% relative humidity. Carbonation curing may be carried out in a sealed enclosure with CO₂ introduced either as a steady gas or as a continuously-circulated gas.

In some embodiments, the curing of the conditioned intermediate includes exposing the formed intermediate to the gas containing carbon dioxide at a pressure ranging from 0 psi to 120 psi. In some embodiments, the curing of the conditioned intermediate includes curing the conditioned intermediate for from 5 minutes to 72 hours. In some embodiments, the curing of the conditioned intermediate includes curing the conditioned intermediate at a temperature ranging from 20° C. to 80° C. In some embodiments, the curing of the conditioned intermediate includes curing the conditioned intermediate at a relative humidity ranging from 30% to 90%.

### Hydration

For carbonated precast concrete made of binders with hydraulic activity such as OPC, hydration curing may optionally be implemented to help carbonated precast concrete achieving full strength. During the hydration curing, carbonated precast concrete products are stored in humid environment for 1 day or longer following the general procedure known in the industry.

### Moisturizing

The carbonated precast concrete may be moisturized. This moisturizing step may include, for example, submerging the cured intermediate in water; spraying the cured intermediate with water; and/or misting the cured intermediate with water. In certain embodiments, therefore, the cured intermediate is moisturized by being soaked in tap water or water saturated with hydrated lime for a period not longer than 24 hours, or by being sprinkled, sprayed and/or misted with tap water. In certain embodiments, this moisturizing is performed for period of time from 0.5 to 48 hours. The preferred moisture content increase for the moisturized carbonated precast concrete is 0.5% by weight or higher. There can be a delay of up to 24 hours between the proposed moisturizing step and the followed post-hardening treatment. Such a moisturizing step can be advantageous for carbonated precast concrete made of a binder with hydraulic activity. Optionally, water used for soaking/spraying can contain minerals/chemicals like efflorescence reducer admixture or water repellent. Alternatively, carbonated precast concrete can be surrounded by water vapour during the post-hardening treatment.

At step 208, a carbon curing is performed to obtain the concrete product. In some embodiments, the carbonation reaction between calcium-rich materials and carbon dioxide occurs once calcium leached from the material and CO₂ are dissolved in water. In a concrete sample, the carbonation reaction generally happens at a specified pore saturation. Once the pores are filled with water and the saturation rate is at or near 100%, there is little to no carbonation reaction. This observation is also valid when there is no water in the pore, or where the pore saturation is zero percent. The optimum pore saturation, or in simpler terms, the moisture content of the mix, results in the highest carbonation reaction rate. Diverging from the optimum moisture content may lead to a lower carbonation reaction and lower concrete performance.

In some embodiments, the concrete product may be wet or moisturized. In some embodiments, the carbonated precast concrete is soaked in tap water or water saturated with hydrated lime for a period not longer than 24 hours, or by being sprinkled with tap water. The preferred moisture content increase for the moisturized carbonated precast concrete is 0.5% by weight or higher, for example at least 0.55%, at least 0.6%, at least 0.65%, at least 0.7%, or at least 0.75%. There can be a delay of up to 24 hours between the optional wetting/moisturizing step and the followed post-hardening treatment. The described wetting or moisturizing step can be advantageous for carbonated precast concrete made of a binder with hydraulic activity. Optionally, water used for soaking/spraying can contain minerals/chemicals like efflorescence reducer admixture or water repellent. Alternatively, carbonated precast concrete can be surrounded by water vapour during the post-hardening treatment. Therefore, in some embodiments the steps of moisturizing and curing may overlap or may occur concurrently.

In some embodiments, during the water absorption testing, carbonated precast concrete is immersed in water for 24 hours and then oven-dried for not less than 24 hours at 100-115° C.

### Concurrent Conditioning & Curing

The steps of conditioning the formed intermediate at 206 may be performed concurrently with the step of curing at 208. In other words, the method 200 may include concurrently conditioning and curing the formed intermediate. This may comprise conditioning the formed intermediate while curing the formed intermediate, wherein the formed intermediate is concurrently cured and conditioned to obtain final water-to-binder ratio less than the first water-to-binder ratio. In other words, while the formed intermediate is being cured, a water content of the formed intermediate decreases from the first water-to-binder ratio to a final water-to-binder ratio. Stated differently, the concurrent conditioning and curing may include conducting a curing process of the formed intermediate, the curing process being initiated at a first time and completed at a second time, and conditioning the formed intermediate between the first time and the second time.

Herein, the expression “concurrent” denotes that two processes occur at the same time, simultaneously. In other words, while the formed intermediate is being cured, some water is being evaporated out of it as part of the conditioning process. Typically, the water-to-binder ratio is constant during the curing process because the water that is not required for the concrete composition has been removed during the conditioning process which is performed before the curing process. In the present method 200, the curing of the formed intermediate occurs while, at the same time, excess water is being evaporated out of the formed intermediate.

In the embodiment shown, the step of concurrently conditioning and curing the formed intermediate may include inserting the formed intermediate in the enclosure 12 sealed from an environment outside the enclosure 12. Then, carbon dioxide at a concentration being at least 5% by volume is injected in the enclosure 12. Other concentrations are contemplated. In the present embodiment, the step of concurrently conditioning and curing the formed intermediate includes absorbing water evaporated from the formed intermediate during the concurrent conditioning and curing. The absorbing of the water evaporated from the formed intermediate may include absorbing the water with a desiccant material contained within the enclosure 12. In some embodiments, a dehumidifier may be used to extract humidity from the enclosure 12. The concurrent conditioning and curing may be performed free of additional external sources of heat and/or free of pressure (e.g., mechanical pressure).

In the embodiment shown, the moisture content and/or water content of the concrete mixture may be reduced from high moisture content to the optimum moisture content, and may even go below the optimum moisture content required for the carbonation reaction. The presence of carbon dioxide inside the chamber/enclosed environment/vessel 12 during the concurrent conditioning and curing process may result in a calcium carbonate precipitation that may improve strength development in concrete products. In other words, the accelerated carbonation curing occurs while the relative humidity of the chamber 12A of the enclosure 12 is kept low. Any precast concrete products, including but not limited to concrete masonry units, paving stones, retaining walls, slabs, traffic barriers, pipes, culverts, etc., can be produced with the proposed process.

In the current disclosure, the pore saturation may be reduced during concurrent conditioning and carbonation curing. The fresh concrete products are dried or semi-dried with the help of reduced relative humidity. Low relative humidity (RH) can be obtained by the presence of absorbent materials and/or elevated temperature combined with air flow (e.g., with the blower 17) inside the chamber for better efficiency. In some embodiments, the air flow speed generated by the blower 17 or other suitable means may be at least 0.1 m/s. The absorbent or desiccant materials may be silica gel, clay, calcium oxide, calcium chloride, molecular sieve, activated charcoal, any other industrial absorbents or a combination of any of these. The presence of the absorbent in an enclosed environment with air flow generated by the fan or blower 17 or by other means may gradually reduce the moisture content of the fresh concrete. The circulated air can be cold or hot. The RH inside the chamber 12A may also be lowered using any mechanical equipment including dehumidifiers that use heating and ventilation or condensation methods for extracting water from the air.

Air circulation rate can vary during the concurrent conditioning and curing. In some cases, the blower 17 may be non-operational (e.g., no air flow). This implies that the carbon dioxide inside the enclosure 12 is stationary. This may be done with the controller 20 varying a rotational speed of the blower 17. The amount of absorbent materials 21 required may depend on the type of material used, the total water content in the concrete products, the type of concrete products and the required or target specifications sought. The fresh air can be introduced into the chamber 12A from outside the chamber, or in another embodiment from inside the closed chamber. In other words, a port 12B (FIG. 1) may be provided to insert air through one of the walls of the enclosure 12. The simultaneous conditioning and CO₂ curing process may further continue to reduce the moisture content of concrete products even after the carbonation reaction stops. The absorbent materials 21 may be used for several cycles. The absorbent materials may be replaced by new materials after they lose their capacity for capturing moisture from the air. The absorbent materials can be placed in any position inside the chamber, or can be distributed uniformly inside the chamber.

In another embodiment, the concurrent conditioning and curing step may be executed by introducing and circulating high-temperature air. If the hot and dry air is introduced into the chamber, the utilization of absorbent materials will be optional.

In another example, the air inside the chamber may be heated by elements, heaters and other known means. If the air inside the chamber is heated up, the utilization of absorbent materials may be optional. In another embodiment, the body of the chamber may heated by external heating blanket and other known means in prior art. If the body of the chamber is heated up while the CO₂ curing process is underway, the utilization of absorbent materials will be optional. A combination of one or two of the above conditioning methods can be implemented.

The demoulded fresh concrete may be contacted with carbon dioxide, CO₂ or a gas containing CO₂ while its moisture content is reduced during the simultaneous water extraction and CO₂ curing process. The carbon dioxide gas introduced to cure the concrete is at 5%, preferably 10%, preferably 20%, preferably 30%, preferably 40%, preferably 50%, preferably 60%, preferably 70%, preferably 80%, preferably 90%, or preferably 99.5% purity. The gauge pressure of the gas will gradually increase to a range of 0.1 psi and optionally to 100 psi.

The concrete products may be kept under conditioning and CO₂ pressure for a given time limit, which may be at least 10 minutes, though the simultaneous conditioning and CO₂ curing process may continue for up to 48 hours.

The concurrently conditioning and curing of the formed intermediate may include concurrently conditioning and curing the formed intermediate free of additional external sources of heat and/or pressure.

In some embodiments, the drying rate can be varied in the presence of carbon dioxide during the concurrent conditioning and curing. Drying variation may be provided by different means such as airflow having a varying speed, temperature variation, or relative humidity variation (by one or more of a desiccant material and mechanical means).

The step of concurrent conditioning and curing may be achieved without additional external source of heat. In some embodiments, the step of concurrent conditioning and curing may be achieved with additional external source of heat.

### Post-Hardening

In the embodiment shown, the method 200 may include a step of subjecting the concrete product, which is referred to below as a cured intermediate, to a post-hardening treatment after the carbon curing at 208. This post-hardening treatment may include exposing the cured intermediate to a temperature above an ambient temperature to perform a post-hardening treatment. It may include exposing the cured intermediate to the temperature being at least 30 degrees Celsius. Preferably, the cured intermediate is exposed to a temperature being from at least 40 to 150 degrees Celsius, preferably, from 80 to 100 degrees Celsius.

In some embodiments, the exposing of the cured intermediate to the temperature may include increasing a temperature of the chamber 12A containing the cured intermediate at a rate ranging from 20 to 120 degrees Celsius per hour. Then, the temperature inside the curing chamber may be maintained above at least 30 degrees Celsius. The exposing of the cured intermediate to the temperature above the ambient temperature may include exposing the cured intermediate to an environment having a relative humidity of from 10% to 90%. The exposing of the cured intermediate to the temperature above the ambient temperature may include exposing the cured intermediate to the temperature for from 1 hour to 72 hours, preferably for at least 6 hours.

In some embodiments, the exposing of the cured intermediate to the temperature above the ambient temperature is performed immediately after the carbon curing of 208. Alternatively, the cured intermediate may be stored at suitable conditions before the exposing of the cured intermediate to the temperature above the ambient temperature.

This post-hardening treatment is an additional step to the carbonation step in precast concrete production in order to strengthen CO₂ cured concrete products. It is generally believed that the durability, such as freeze-thaw resistance, of a strengthened precast concrete should also be improved. Therefore, this added step can enhance the mechanical properties and durability of carbonated precast concrete and/or reduce the material cost in its production.

Post-hardening treatment is executed on already carbonated precast concrete. During the post-hardening treatment, carbonated precast concrete is exposed to a temperature higher than ambient temperature for a specified period. In other words, carbonated precast concrete is baked under heat for a specified period after carbonation curing. The temperature used for treating carbonated precast concrete can be 40° C. up to 150° C. A treating temperature of 80° C. or higher is preferred. In some cases, a treating temperature of 100° C. or higher is preferred. To reach the specified treating temperature, the temperature increasing rate can be 20-120° C./hour at the beginning of the post-hardening treatment. After the specified treating temperature is reached, it can be maintained until the post-hardening treatment is completed. Alternatively, carbonated precast can be loaded into the treatment enclosure after the enclosure has been heated up to the specified temperature. The duration of post-hardening treatment can be 1 hour or longer. The duration of post-hardening treatment is more preferred to be 6 hours or longer but shorter than 72 hours. During the post-hardening treatment, the relative humidity surrounding carbonated precast concrete can be 10% up to 90%. Detailed temperature and duration of post-hardening treatment depends on the types of raw materials especially the types of binders, percentage of binders, thickness of products, concrete mix proportions, relative humidity, the degree of carbonation curing and the desired performance for the treated carbonated precast concrete.

In some embodiments, the post-hardening treatment is preferred to start after the carbonation curing of precast concrete is completed without delay. However, post-hardening treatment can also be conducted after carbonated precast concrete is stored under normal condition for an unspecified period.

In some embodiments, the post-hardening treatment is preferred to be carried out in the chamber where carbonation curing takes place. However, post-hardening treatment can be carried out in another enclosure after carbonated precast concrete is removed from the carbonation curing chamber. During the post-hardening treatment, the treatment enclosure can be sealed or un-sealed, although a sealed enclosure is preferred.

Heating during the post-hardening treatment can be achieved through conventional methods, such as gas or oil burner, boiler, infrared heating element, and so on. In another embodiment, the heat generated during the carbonation curing process can be recycled and re-used for the post-heat treatment process. An air circulation system is needed to bring hot air from the heat source to the treatment enclosure, and also evenly distribute heat surrounding carbonated precast concrete. This air circulation system may also have the function of taking the accumulated moisture in the air out of the treatment enclosure, if it is desired.

The performance enhancement of carbonated precast concrete by the current post-hardening treatment is believed to be the result of the generation of bigger and stronger calcium carbonate particles in carbonated precast concrete after post-hardening treatment. In other words, most stable calcium carbonates are generated inside carbonated precast concrete due to the post-hardening treatment, which contribute to the enhanced mechanical and durability properties. In addition, some of unreacted dissolved calcium ions and carbonate in the carbonated precast concrete may get a chance to precipitate more once the temperature goes up, thus increasing the strength and durability of carbonated precast concrete. Furthermore, some of the uncarbonated dissolved calcium silicates may hydrate under elevated temperature, which contributes to the strength development of carbonated precast concrete. Additionally, the structure and crystallinity of the generated calcium carbonates during the carbonation curing process can be improved, resulting in an improved microstructure and structure as a result of the proposed post-hardening treatment.

The post-hardening treatment includes exposing the precast concrete to a heat treatment to a temperature of at least 30° C. to obtain the concrete product. In some embodiments, the post-hardening treatment has a duration of at least 1, 2, 3, 4, 5, 6, 8, 10, 12, 18 or 24 hours and may have an upper boundary of 72 hours. In some embodiments, the post-hardening treatment is performed at a temperature of at least 35° C., at least 40° C., at least 45° C., at least 50° C., at least 55° C., at least 60° C., at least 65° C., at least 70° C., at least 75° C., at least 80° C., at least 85° C., at least 90° C., at least 95° C., at least 100° C., from 30 to 150° C., from 40 to 150° C., from 50 to 150° C., from 60 to 150° C., from 70 to 150° C., from 80 to 150° C., or from 80 to 110° C.

Below are some examples with a purpose to demonstrate that desirable characteristics may be obtained by the post-hardening treatment of carbonated precast concrete using the methods of the present disclosure. Neither the raw materials nor the processes will be limited to the ones given in these examples.

### EXAMPLES

Below are some examples with a purpose to demonstrate that desirable characteristics may be obtained by manufacturing the disclosed carbonated precast concrete with the methods of the present disclosure. Neither the raw materials nor the processes will be limited to the ones given in these examples.

### Raw Materials and General Procedure Used in the Examples

Steel slag is the sole binder used for carbonated precast concrete production. It is a ladle slag, with a combined calcium oxide and magnesium oxide content of 42%, and a silicon dioxide content of about 20%. Its weight content in the prepared concrete mixtures is kept at a constant number for all samples.

Water used is tap water. The ideal amount of initial water for mixing each sample is determined by visual inspection: with the weights of steel slag and aggregate(s) kept constant, mixture is obtained by varying the initial water amount; the obtained mixture is cast into a mould and then consolidated with a preset vibro-compression method; the minimum amount of water required to consolidate the mixture to the targeted density is regarded as the ideal initial water amount. The actual initial water-to-binder ratio with the determined ideal initial water amount is in the range of 0.10-0.40 for all samples, with a greater initial water demand for precast concrete made of finer aggregate.

Conditioning is conducted at room conditions with the help a blowing fan in a predetermined period.

Compressed CO₂ in cylinders with a purity of up to 99.9% is used for carbonation curing. Carbonation curing is conducted in a pressure chamber for a duration of up to 19 hours at 2-15 psi CO₂ pressure.

Aggregates for making control sample are coarse aggregate (crushed stone) and fine aggregate A (natural sand). Aggregates used for other sample making including screened fine aggregate A, fine aggregates B, C and D and screened fine aggregate A removed with coarse (>2.36 mm) and fine (<0.15 mm) particles. The physical properties of the used aggregates and their sieve analyzing results are included in specific examples.

The mass change of precast concrete prior to and after carbonation curing is recorded, together with the condensation water collected inside the pressure chamber. These data are used for calculating CO₂ uptake. Immediately after carbonation curing, the compressive strength of all carbonated precast concrete samples is evaluated following ASTM C140 for concrete masonry units, together with the water absorption and moisture content of some samples. Additionally, the freeze-thaw resistance of two control samples and the samples made of fine aggregate C and D is tested by partly submerging each sample in 3% NaCl solution, following ASTM C1262 for segmental retaining wall. For each evaluated property, two replicates are made, and the average result is reported.

### Example 1—Control Samples Made of Combined Used of Coarse Aggregate and Fine Aggregate

Control samples are made with coarse aggregate and fine aggregate A. The properties of these two aggregates are recorded in Table 1. Their sieve analyzing results are shown in FIG. 4. The weight ratio of coarse aggregate to fine aggregate is fixed at 1:4 in manufacturing control samples. These two aggregates and their ratio are currently used in manufacturing commercial precast concrete products. The conditioning time needed for conditioning these samples and the performance of the resultant carbonated precast concrete are used to determine the benefits of applying the current disclosure in manufacturing carbonated precast concrete.

In the table below, fine aggregate A has 11% of accumulated mass retained on No. 8 sieve (2.36 mm opening), including the parts retained on No. 4 sieve (4.75 mm opening), and ⅝″ sieve (9.50 mm opening).

TABLE 1
Physical Properties of Coarse Aggregate and Fine Aggregate A

| | | | | Loose | Rodded | | |
|---|---|---|---|---|---|---|---|
| | | Moisture | Water | Density | Density | Specific | Fineness |
| Aggregate Name | Source | Content | Absorption | (kg/m³) | (kg/m³) | Gravity | Modulus |
| Coarse aggregate | Crushed | 0.2% | 3.3% | 1485 | 1591 | 2.60 | — |
| | stone | | | | | | |
| Fine aggregate A | Natural | 0.3% | 1.6% | 1649 | 1775 | 2.60 | 2.49 |
| | sand | | | | | | |

After being demolded, the control samples are conditioned in front of a fan for 0.25 hour, 0.5 hour, 1 hour and 2 hours, respectively, prior to carbonation curing. The average CO₂ uptake, ambient density, strength, CO₂ penetration and other properties of the prepared comparative samples under changing conditioning time are provided in Table 2. The properties of carbonated precast concrete are affected greatly by conditioning time. With the increase of conditioning time up to 1 hour, the improvement in the properties of carbonated precast concrete, except its ambient density, is observed. After 1-hour conditioning, no apparent change in the performance of carbonated precast concrete is found. For carbonated precast concrete made of combined coarse and fine aggregate, a 1-hour conditioning time is required to achieve 100% CO₂ penetration, 15% CO₂ uptake and a satisfactory strength. If the conditioning time is shorter than 1 hour, the performance of carbonated precast concrete is not acceptable. At 0.5-hour conditioning time, the performance of carbonated precast concrete is poor and not acceptable, with a CO₂ uptake of 12%, a strength of 30 MPa, and a CO₂ penetration of only 55%. At 0.25-hour conditioning time, the performance of carbonated precast concrete is even worse, with a CO₂ uptake of only 5%, a strength of only 9 MPa, and a CO₂ uptake of only 10%. The moisture content and water absorption of the measured control samples are around 2.5%, and 5.0%, respectively. The freeze-thaw resistance of samples Comparison 1.3 and Comparison 1.4 is tested, with the testing results shown and discussed in Example 4.

TABLE 2
Properties of Control Samples

| | Aggregate | Conditioning | CO₂ | Density | Strength | CO₂ | Moisture | Water |
|---|---|---|---|---|---|---|---|---|
| Samle ID | Type | Time (hr) | Uptake | (kg/m³) | (MPa) | Penetration | Content | Absorption |
| Comparison 1.1 | Combined | 0.25 | 4.5% | 2292 | 9 | 10% | — | — |
| Comparison 1.2 | Combined | 0.5 | 11.6% | 2345 | 30 | 55% | — | — |
| Comparison 1.3 | Combined | 1 | 15.3% | 2323 | 42 | 100% | 2.2% | 5.1% |
| Comparison 1.4 | Combined | 2 | 15.0% | 2320 | 44 | 100% | 2.8% | 4.9% |

Note:
combined = combined coarse aggregate and fine aggregate at a mass ratio of 1:4.

### Example 2—Samples Made of Screened Fine Aggregate A

Fine aggregate A is screened to pass No. 8 (2.36 mm opening), No. 16 (1.18 mm opening), No. 30 (0.6 mm opening), and No. 50 (0.3 mm opening), respectively. After screening, the part that has passed through each designated sieve is collected for carbonated precast concrete sample preparation. With the same conditioning environment as preparing the control samples in Example 1, consolidated precast concrete is conditioned for 0.25 hour and 0.5 hour, respectively. Additionally, for comparison purpose, control sample is made of original fine aggregate A (no screening) with a conditioning time of 0.5 hour. Carbonation curing is then conducted and the properties of the carbonated samples are shown in Table 3.

The effect of reducing aggregate's particle size on reducing conditioning time is obvious. For the control sample (Comparison 2) which is made of original fine aggregate A (no screening), its performance is relatively poor after 0.5 hour conditioning. Its CO₂ uptake, strength and CO₂ penetration are only 11%, 32 MPa, and 85%, respectively. For samples made of fine aggregate A passing No. 8 (2.36 mm opening) and conditioned for 0.5 hour, CO₂ uptake reaches 15%, while strength is 40 MPa with 100% CO₂ penetration. When even finer aggregate is used by screening fine aggregate A through No. 16 sieve (1.18 mm opening), carbonated precast concrete after 0.25 hour conditioning has better performance than Comparison 2, with CO₂ uptake, strength and CO₂ penetration of 13%, 42 MPa, and 90%, respectively. Similar improvements are observed when using finer aggregate by screening fine aggregate A through No. 30 or No. 50 sieve. In addition, if the results in Tables 2 and 3 are compared, significant increases in CO₂ uptake, strength and CO₂ penetration for carbonated precast concrete made of finer aggregates and conditioned at the same duration can be observed.

TABLE 3
Properties of Samples Made of Refined Fine Aggregate A

| | | Fineness | Conditioning | CO₂ | Density | Strength | CO₂ | Moisture | Water |
|---|---|---|---|---|---|---|---|---|---|
| Sample ID | Particle Size | Modulus | Time (hr) | Uptake | (kg/m³) | (MPa) | Penetration | Content | Absorption |
| 2.1.1 | Passing 2.36 | 2.2 | 0.25 | 9.4% | 2322 | 20 | 80% | — | — |
| | mm sieve | | | | | | | | |
| 2.1.2 | Passing 2.36 | 2.2 | 0.5 | 14.5% | 2289 | 40 | 100% | 2.7% | 5.7% |
| | mm sieve | | | | | | | | |
| 2.2.1 | Passing 1.18 | 1.9 | 0.25 | 12.9% | 2320 | 42 | 90% | — | — |
| | mm sieve | | | | | | | | |
| 2.2.2 | Passing 1.18 | 1.9 | 0.5 | 14.0% | 2262 | 37 | 93% | 3.7% | 6.1% |
| | mm sieve | | | | | | | | |
| 2.3.1 | Passing 0.60 | 1.5 | 0.25 | 11.7% | 2171 | 31 | 95% | — | — |
| | mm sieve | | | | | | | | |
| 2.3.2 | Passing 0.60 | 1.5 | 0.5 | 15.8% | 2263 | 36 | 90% | — | — |
| | mm sieve | | | | | | | | |
| 2.4.1 | Passing 0.30 | 0.8 | 0.25 | 12.1% | 2249 | 29 | 85% | — | — |
| | mm sieve | | | | | | | | |
| 2.4.2 | Passing 0.30 | 0.8 | 0.5 | 14.8% | 2211 | 34 | 85% | — | — |
| | mm sieve | | | | | | | | |
| Comparison 2 | Original Fine | 2.5 | 0.5 | 11.1% | 2300 | 32 | 85% | — | — |
| | Aggregate A | | | | | | | | |

The measured water absorption values are slightly greater than that of the control samples in Example 1, mainly due to the slightly greater moisture contents of samples made of finer aggregate as a result of a slightly higher initial water-to-binder ratio used with finer aggregate.

### Example 3—Samples Made of Fine Aggregate B

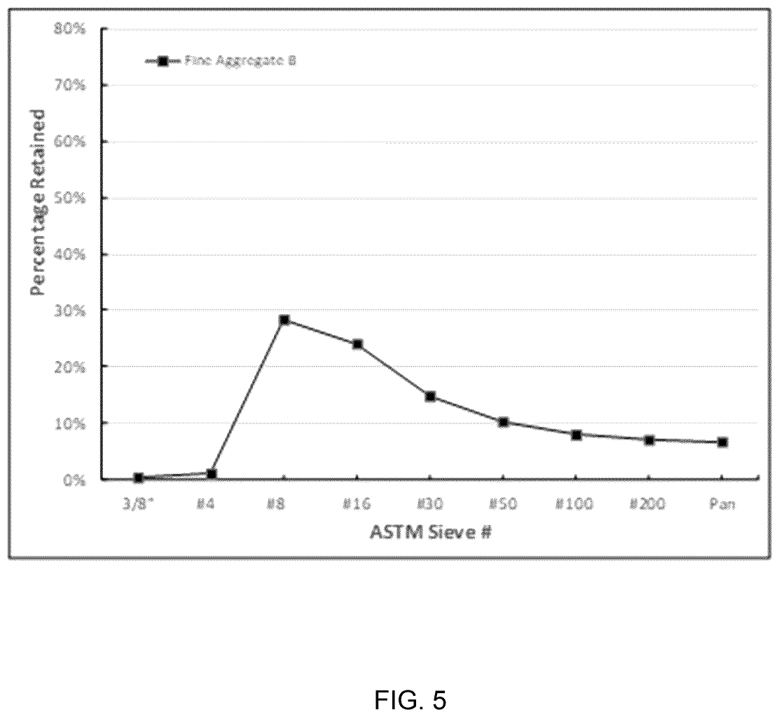

Commercially available fine aggregate B is purchased from a local aggregate supplier. It is a manufactured sand from crushed limestone. Its properties are recorded in Table 4. Particle size analyzing is conducted and the results are displayed in FIG. 5. Because this aggregate has almost 30% of accumulated mass of particles retained on No. 8 sieve (2.36 mm opening) and larger-size sieves, some or all of this part of coarse particles has to be removed before this aggregate can be accepted for carbonated precast concrete production. Therefore, fine aggregate B is screened with No. 8 sieve (2.36 mm opening) and No. 16 sieve (1.18 mm opening), respectively. After screening, the particles that have passed each designated sieve are collected for carbonated precast concrete sample preparation.

TABLE 4
Physical Properties of Coarse Aggregate and Fine Aggregate B

| | | | | Loose | Rodded | |
|---|---|---|---|---|---|---|
| | | Moisture | Water | Density | Density | Specific |
| Aggregate Name | Source | Content | Absorption | (kg/m³) | (kg/m³) | Gravity |
| Fine aggregate B | Crushed | 2.6% | 1.9% | 1319 | 1580 | 2.74 |
| | limestone | | | | | |

With the same conditioning environment as preparing the control samples in Example 1, consolidated precast concrete is conditioned for 0.5 hour. Carbonation curing is then conducted and the properties of the carbonated samples are shown in Table 5. For comparison, carbonated precast concrete samples are also made with the original fine aggregate B (no screening), with a conditioning time of 0.5 hour or 1 hour chosen. Their testing results are also included in Table 5.

TABLE 5
Properties of Samples Made of Original or Refined Fine Aggregate B

| | | Fineness | Conditioning | CO₂ | Density | Strength | CO₂ |
|---|---|---|---|---|---|---|---|
| Sample ID | Particle Size | Modulus | Time (hr) | Uptake | (kg/m³) | (MPa) | Penetration |
| 3.1 | Passing 2.36 | 2.4 | 0.5 | 16.5% | 2329 | 52 | 90% |
| | mm sieve | | | | | | |
| 3.2 | Passing 1.18 | 1.6 | 0.5 | 14.7% | 2232 | 45 | 100% |
| | mm sieve | | | | | | |
| Comparison | Original Fine | 3.2 | 0.5 | 11.8% | 2344 | 39 | 75% |
| 3.1 | Aggregate B | | | | | | |
| Comparison | Original Fine | 3.2 | 1 | 15.8% | 2347 | 45 | 100% |
| 3.2 | Aggregate B | | | | | | |

For the control sample Comparison 3.1 which is made of original fine aggregate B (no screening), its CO₂ uptake (12%) and CO₂ penetration (75%) are not acceptable when the conditioning time is 0.5 hour. By removing particles coarser than 2.36 mm from fine aggregate B, carbonated precast concrete after only 0.5 hour conditioning has a CO₂ uptake of 17%, a strength of 52 MPa, and 90% CO₂ penetration, showing a better performance than Comparison 3.1 and Comparison 3.2 (1 hour conditioning). Compared to the performance of the control samples in Table 2, the improvements in CO₂ uptake and strength are even more significant. Similar improvements can also be found from the testing results of carbonated precast concrete made by removing particles coarser than 1.18 mm from fine aggregate B.

### Example 4—Samples Made of Fine Aggregates C and D

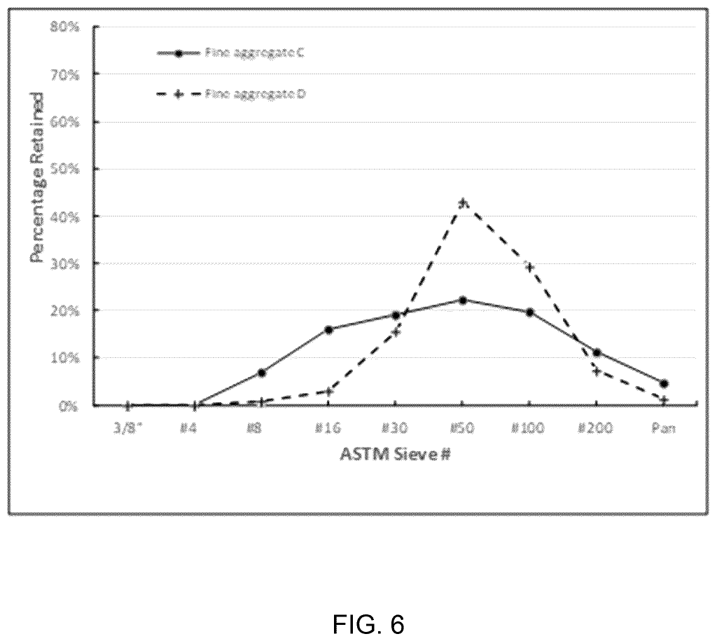

Commercially available fine aggregates C and D are purchased from a local aggregate supplier. They are manufactured sand from crushed granite and natural sand, respectively. Their properties are recorded in Table 6. Particle size analyzing is conducted and the results are displayed in FIG. 6. Fine aggregates C and D have accumulated 7% and 1% by mass of the particles retained on No. 8 sieve (2.36 mm opening), respectively. These values are smaller than the 10% specified by step 202 in FIG. 2A, they can therefore be used directly for carbonated precast concrete production.

TABLE 6
Physical Properties of Fine Aggregates C and D

| | | | | Loose | Rodded | |
|---|---|---|---|---|---|---|
| Aggregate | | Moisture | Water | Density | Density | Specific |
| Name | Source | Content | Absorption | (kg/m³) | (kg/m³) | Gravity |
| Fine | Crushed | 0.1% | 0.5% | 1667 | 1816 | 2.79 |
| aggregate | granite | | | | | |
| C | | | | | | |
| Fine | Natural | 1.1% | 1.4% | 1533 | 1663 | 2.59 |
| aggregate | sand | | | | | |
| D | | | | | | |

With the same conditioning environment as preparing the control samples in Example 1, consolidated precast concrete samples are conditioned for 0.5 hour. Carbonation curing is then conducted and the properties of the carbonated samples are shown in Table 7.

TABLE 7
Properties of Samples Made of Original or Refined Fine Aggregate C

| Sample | Aggregate | Fineness | Conditioning | CO₂ | Density | Strength | CO₂ | Moisture | Water |
|---|---|---|---|---|---|---|---|---|---|
| ID | Type | Modulus | Time (hr) | Uptake | (kg/m³) | (MPa) | Penetration | Content | Absorption |
| 4 | Fine | 2.2 | 0.5 | 15.2% | 2334 | 48 | 100% | 3.8% | 6.0% |
| | Aggregate C | | | | | | | | |
| 5 | Fine | 1.8 | 0.5 | 15.6% | 1151 | 41 | 100% | 3.6% | 6.4% |
| | Aggregate D | | | | | | | | |

For carbonated precast concrete made of fine aggregate C and with a 0.5-hour conditioning time, it has a CO₂ uptake of 15%, a strength of 48 MPa, and a CO₂ penetration of 100%. For carbonated precast concrete made of fine aggregate D and with a 0.5-hour conditioning, it has a CO₂ uptake of 16%, a strength of 41 MPa, and a CO₂ penetration of 100%. These results are comparable to the results of control sample Comparison 1.3 in Table 2, which is conditioned for 1 hour, but they are much better than that of Comparison 1.2 which is conditioned for 0.5 hour. The measured water absorption is slightly greater than that of the control samples in Example 1, mainly due to the slightly greater moisture contents of the samples with finer aggregates as a result of a slightly higher water-to-binder ratio prior to carbonation curing.

The freeze-thaw resistance of samples made of fine aggregates C and D is also assessed, and then compared with the performance of samples Comparison 1.3 and 1.4. As shown in FIG. 7, the control samples have poor freeze-thaw resistance. For sample Comparison 1.4 listed in Table 2 above, it is totally decomposed before reaching 30 cycles of freeze-thaw testing. For sample of Comparison 1.3, it loses almost 40% of its original mass after 40 cycles of freeze-thaw testing. Compared to these two control samples, the improvement in freeze-thaw resistance of carbonated precast concrete manufactured with the currently disclosed method is noticeable. After 40 cycles of freeze-thaw testing in 3% NaCl solution, accumulated mass losses are 13.6% and 4.6%, respectively, for carbonated precast concrete made of fine aggregates C and D. Hence, the inventors of the present disclosure discovered that using fine aggregates may improve freeze-thaw resistance.

### Example 5—Samples Made of Combined Used of Crushed Stone and Screened Fine Aggregate a Removed with Coarse (>2.36 mm) and Fine (<0.15 mm) Particles

Fine aggregate A is screened to pass No. 8 (2.36 mm opening) and No. 100 (0.15 mm opening), respectively. After screening, the part retained No. 100 sieve (0.15 mm), is collected for carbonated precast concrete sample preparation in combination with coarse crushed stone aggregate with a weight ratio of coarse to fine is fixed at 1:4. With the same conditioning environment as preparing the control samples in Example 1, consolidated precast concrete is conditioned for 0.5 hour. Additionally, for comparison purpose, control sample is made of original fine aggregate A (no screening) with a conditioning time of 0.5 hour. Carbonation curing is then conducted, and the properties of the carbonated samples are shown in Table 8.

TABLE 8
Properties of Samples Made of Coarse Stone and Sieved Fine Aggregate A

| | | Conditioning | CO₂ | Density | Strength | CO₂ |
|---|---|---|---|---|---|---|
| Sample ID | Aggregate type | time (hr) | Uptake | (kg/m³) | (MPa) | Penetration |
| 5.1 | Coarse and Sieved | 0.5 | 15.6% | 2385 | 51 | 100% |
| | Fine Aggregate A | | | | | |
| Comparison 5 | Coarse and Fine | 0.5 | 11.6% | 2345 | 30 | 55% |
| | Aggregate A | | | | | |

These results of sample made of sieved fine aggregate are better than of control sample Comparison 1.3 in Table 2, which is conditioned for 1 hour, but they are much better than that of Comparison 5 which is conditioned for 0.5 hour. Put differently, and as shown in Table 8, the use of fine aggregate leads to an increase in compressive strength (51 MPa vs 30 MPa) and increases the CO2 penetration (100% vs 55%).

### Controller

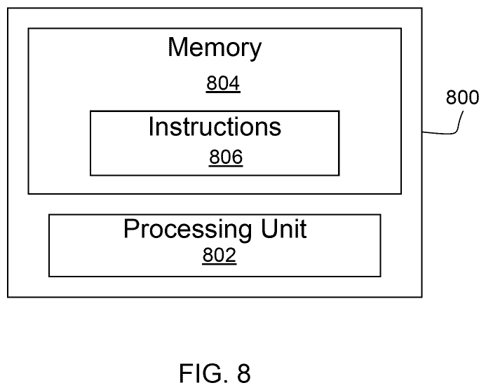

Referring now to FIG. 8, the controller 20 may include a computing device 800, which may comprise a processing unit 802 and a memory 804 which has stored therein computer-executable instructions 806. The processing unit 802 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 804 may comprise any suitable known or other machine-readable storage medium. The memory 804 may comprise non-transitory computer readable storage medium, for example, but not limited to, an electronic, magnetic, optical, electromagnetic, infrared, or semiconductor system, apparatus, or device, or any suitable combination of the foregoing. The memory 804 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may comprise any storage means (e.g., devices) suitable for retrievably storing machine-readable instructions 806 executable by processing unit 802.

The methods and systems for operating the system 10 described herein may be implemented in a high level procedural or object oriented programming or scripting language, or a combination thereof, to communicate with or assist in the operation of a computer system, for example the computing device 800. Alternatively, the methods and systems for operating the system 10 may be implemented in assembly or machine language. The language may be a compiled or interpreted language. Program code for implementing the methods and systems for operating the system 10 may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for operating the system 10 may also be considered to be implemented by way of a non-transitory computer-readable storage medium having a computer program stored thereon. The computer program may comprise computer-readable instructions which cause a computer, or more specifically the processing unit 802 of the computing device 800, to operate in a specific and predefined manner to perform the functions described herein, for example those described in the method 200.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

In the context of the present disclosure, the expression “about” provided in the context of any specific value or range of values implies variations of plus or minus 10% of the value provided. Additionally, the examples provided herein are understood to be exemplary, and not limitative. Accordingly, those skilled in the art will readily appreciate that alternatives to these examples may exist, and that variations may be possible without departing from the scope of the teachings of the present disclosure in its entirety.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A method of manufacturing a concrete product, comprising:
mixing a composition including a binder, water, and an aggregate to produce a concrete mixture, a major portion of a weight of the aggregate attributed to particles sized to pass through sieve openings of about 2.36 mm;
imparting a form to the concrete mixture to provide a formed intermediate;
conditioning the formed intermediate to obtain a conditioned intermediate; and
curing the conditioned intermediate with a gas containing carbon dioxide to obtain the concrete product.

2. The method of claim 1, wherein the conditioning of the formed intermediate includes conditioning the formed intermediate for about 50% less time than if the composition of the formed intermediate were made with a reference aggregate, a major portion of a weight of the reference aggregate attributed to particles sized to be retained by the sieve openings of about 2.36 mm.

3. The method of claim 1, wherein at least 90% of the weight of the aggregate is attributed to the particles sized to pass through the sieve openings of about 2.36 mm.

4. The method of claim 1, wherein 100% of the weight of the aggregate is attributed to the particles sized to pass through the sieve openings of about 2.36 mm.

5. The method of claim 1, wherein the major portion of the weight of the aggregate is attributed to particles sized to pass through sieve openings of about 1.18 mm.

6. The method of claim 5, wherein the major portion of the weight of the aggregate is attributed to particles sized to pass through sieve openings of about 0.3 mm.

7. The method of claim 6, wherein the major portion of the weight of the aggregate is attributed to particles sized to pass through sieve openings of about 0.15 mm.

8. The method of claim 7, wherein the major portion of the weight of the aggregate is attributed to particles sized to pass through sieve openings of about 0.075 mm.

9. The method of claim 1, wherein the sieve openings have an area of about 5.57 mm².

10. The method of claim 9, wherein the sieve openings are square.

11. The method of claim 1, comprising mixing the binder, the water, and the aggregate with the particles including one or more of sand, crushed stone, expanded perlite, expanded shale, crushed glass, crushed air-cooled granulated blast furnace slag, recycled concrete, recycled brick, stone rubble.

12. The method of claim 1, wherein the binder includes steel slag.

13. The method of claim 12, wherein the binder is devoid of cement.

14. The method of claim 1, wherein a binder content of the binder ranges from 8% to 50% by weight of the concrete mixture.

15. The method of claim 1, wherein a water-to-binder ratio ranges from 0.15 to 0.5.

16. The method of claim 1, wherein the mixing of the composition includes mixing a chemical admixture with the binder, the aggregate, and the water to produce the composition.

17. The method of claim 1, comprising conditioning the formed intermediate at a temperature ranging from 15° C. to 28° C. and with a relative humidity ranging from 20% to 60%.

18. The method of claim 17, wherein the conditioning of the formed intermediate includes conditioning the formed intermediate until from 20% to 80% by weight of the water is evaporated.

19. The method of claim 1, wherein the curing of the conditioned intermediate includes exposing the formed intermediate to the gas containing carbon dioxide at a pressure ranging from 0 psi to 120 psi.

20. The method of claim 1, comprising mixing the binder, the water, and the aggregate having a dry rodded density of from 1100 kg/m3 to 1850 kg/m3.
